(19) United States
(12) Patent Application Publication
(10) Pub. No.: US 2017/0165623 A1
(43) Pub. Date: Jun. 15, 2017

(54) Slide Valve Intended for Flow Control in a Fluid Catalytic Cracking Unit

(71) Applicant: Total Raffinage Chimie, Courbevoie (FR)

(72) Inventors: Marc Bories, Saint-Nazaire (FR); Michaël Echard, Montivilliers (FR); Romain Lesage, Montivilliers (FR); Lassad Rezgui, Bondy (FR); Jean-Christophe Raboin, Chaumont sur Tharonne (FR)

(21) Appl. No.: 15/327,318

(22) PCT Filed: Jul. 23, 2015
(86) PCT No.: PCT/EP2015/066918

§ 371 Date: Jan. 18, 2017

(30) Foreign Application Priority Data
Jul. 28, 2014 (FR) 1457256

(51) Int. Cl. B01J 8/00; B01J 8/26; C10G 11/18; F16K 3/02

(52) U.S. Cl. CPC B01J 8/002; F16K 3/0263; F16K 3/029; F16K 3/0281; B01J 8/26; C10G 11/18; B01J 2208/00752; B01J 2208/00761

(57) ABSTRACT

The invention relates to a slide valve (200) comprising:

a body (201) having a through-duct (202) for the passage of a fluid, the flow rate of which is to be controlled,

at least one gate (203) slidably mounted inside said body (201), crosswise to said duct (202), and partially or completely closing off said duct (202), said gate (203) being movable between a position in which the duct is partially or completely closed off and a position in which the duct is open,

in which the following are defined as portions subject to erosion:
portions of the body that delimit the duct (202),
at least one portion of said at least one gate (203) located across the duct (202) when said at least one gate partially or completely closes off said duct,
characterized in that at least said portions subject to erosion are made of metal covered with a layer of ceramic material or are entirely made of ceramic material.

The invention relates to a slide valve intended for flow control in a fluid catalytic cracking (FCC) unit, in particular intended for catalyst flow control.

The invention relates to the problems of degradation of the metal walls of the internal equipment of a catalytic cracking unit. These degradation problems may be due to erosion caused by the circulation of abrasive catalyst particles within the catalytic cracking unit or to corrosion, owing to the presence of corrosive gases in certain portions of the catalytic cracking unit.

In an FCC unit, the feedstock to be treated and the catalyst are introduced together into a reactor, the temperature of which may achieve several hundreds of degrees centigrade, for example from 520° C. to 550° C. The gaseous effluents exiting the reactor and produced by the cracking of the feedstock are separated from the particles of solid and coked catalyst in a disengager located downstream of the reactor. The chemical reaction produced in the FCC reactor leads to the formation of deposits of coke on the catalyst particles, requiring a continuous regeneration of this catalyst. The coked and separated catalyst is then transported as a continuous flow to a regenerator in which the coke is burnt off by injection of air. The hot catalyst thus regenerated, which may be classed as a new catalyst, is then reinjected at the inlet of the reactor with the fresh feedstock.

In order to control the flow rates of the fluids circulating in the FCC unit and especially in order to control the flows of catalyst, valves referred to as slide valves are used. A slide valve conventionally comprises a plate or gate (also referred to as a slide or guillotine) which slides in a narrow body through which the fluid to be controlled circulates. Certain slide valves are double-gate valves: two gates slide towards one another in order to close the valve or slide while moving away from one another in order to open the valve. A gate of a slide valve slides in side rails formed in the body. These rails may comprise orifices for introducing a gaseous fluid, generally steam, which is intended to drive the solid particles possibly present out of the rails in order to avoid any blocking of the sliding of a gate.

In an FCC unit, the slide valves are generally made of metal, usually made of stainless steel.

In order to protect these valves from the erosion caused by the circulation of the catalysts, the portions of the valve capable of receiving a flow of solid particles must be protected. These portions subject to erosion especially comprise the portions of the gate and of the body in contact with the flow of solid particles, namely portions of the body delimiting the duct (in other words the walls of the duct) and at least one portion of the gate (or of the gates) located across the duct when the gate partially or completely closes off this duct.

These portions subject to erosion are thus generally covered with a coating consisting of a composite material, in general a concrete, held by an anchoring structure, which is usually metallic. These anchoring structures are welded to the metal portions and thus provide the attachment of the composite material. They may have a honeycomb shape comprising a plurality of hexagonal cells firmly attached to one another via their side. The anchoring structure is then welded to the metal wall by welding of the cells to the metal wall. Each cell is then filled with composite material. Other types of metal anchorings may also be used, for example V-shaped anchorings, these anchorings then being covered with composite material.

Such a coating makes it possible to protect the metal walls that are subject to erosion. However, over time a degradation of this coating, in particular of the coating of the moving portions and of the fixed portion of the valve at the opening zone, is observed which may result in fragments of coating dropping off and in a malfunction of the valve, which may require the shutdown of the plant for maintenance operations.

Moreover, such coatings must be produced manually and are particularly time-consuming and difficult to install. The maintenance operations are thus long and costly. Finally, they considerably weigh down the metal walls covered: indeed this type of coating has a thickness of 2.5 to 6 centimetres, which requires the production of metal walls of great thickness, further increasing the overall cost of the equipment, and which also gives rise to constraints during the design of these walls.

There is therefore a need for slide valves that have a better resistance to erosion and the maintenance of which is not very expensive.

The invention aims to overcome these drawbacks by proposing a slide valve comprising:
a body having a through-duct for the passage of a fluid, the flow rate of which is to be controlled,
at least one gate slidably mounted inside said body, crosswise to said duct, and partially or completely closing off said duct, said gate being movable between a position in which the duct is partially or completely closed off and a position in which the duct is open,

in which the following are defined as portions subject to erosion:
portions of the body that delimit the duct,
at least one portion of said at least one gate located across the duct when said at least one gate partially or completely closes off said duct,

According to the invention, at least said portions of the slide valve subject to erosion are made of metal covered with a layer of ceramic material or are entirely made of ceramic material.

According to a first embodiment, a coating made of ceramic material is thus provided at least on the most exposed portions of the valve, namely the portions subject to erosion defined above. The layer of ceramic material may be from 1 mm to 5 cm depending on the technique used, preferably from 5 mm to 1 cm. This layer may be deposited for example by means of a plasma, by a thermal spraying process, by chemical vapour deposition or physical vapour deposition. The metal may be stainless steel.

According to a second embodiment, at least said portions of the slide valve subject to erosion are made entirely of ceramic material.

As a variant, the body, or at least the portions of the body delimiting the duct, in other words forming the walls of the ducts, and said at least one gate of the slide valve according to the invention may be either made of metal covered with a layer of ceramic material, or entirely made of ceramic material. The slide valve may in particular be made entirely of ceramic material.

In any case, the portions of the slide valve subject to erosion are henceforth devoid of a coating comprising an anchoring structure covered with composite material of concrete or cement type, of the type described above.

The slide valve according to the invention thus has the advantage of being made at least partly of ceramic material, at least for the portions thereof subject to erosion.

Ceramic materials have proved suitable for the usage conditions of an FCC unit. In particular, these materials may have good corrosion resistance and thermal resistance.

Ceramic materials have a relatively high hardness, greater than the catalysts used in the FCC unit, namely a hardness of at least 1400 N/mm² as Vickers hardness. Preferably, the ceramic material has a hardness of greater than 2100 N/mm² or even greater than 2500 N/mm².

Owing to this relatively high hardness, the slide valve according to the invention has the advantage of not requiring the protection of the portions subject to erosion with coatings of the type of those described above for steel walls. The result of this is a considerable weight saving of the slide valve with respect to the steel slide valves customarily used. Owing to the absence of concrete-based protective coating, the risks of the catalyst mixing with components originating from the degradation of the concrete are also reduced.

The manufacture and the maintenance of the slide valves according to the invention are also facilitated with respect to the steel slide valves covered with a concrete-type coating owing to the absence of coating to be installed or to be repaired/replaced. The maintenance operations may also be spaced out or be shorter, which makes it possible to reduce the operating costs of the FCC unit significantly.

The absence of heavy and bulky coating on the portions of the slide valves of the invention subject to erosion makes it possible to eliminate design constraints linked to the presence of these coatings. It is especially possible to reduce the thickness of the walls of the slide valves, in particular when the most exposed portions of the valve are entirely made of ceramic material.

The ceramic material may be selected from silicon carbide SiC, boron carbide B₄C, silicon nitride Si₃N₄, aluminium nitride AlN, boron nitride BN, alumina Al₂O₃, or mixtures thereof.

Preferably, the ceramic material is silicon carbide SiC or comprises silicon carbide SiC, preferably in a majority amount, for example in a content of 60% to 99.9% by weight. Silicon carbide has the advantage of possessing good mechanical and physical properties for a reasonable manufacturing cost.

As a variant, or optionally in combination, the ceramic material may comprise a ceramic matrix selected from silicon carbide SiC, boron carbide B₄C, silicon nitride Si₃N₄, aluminium nitride AlN, alumina Al₂O₃, or mixtures thereof, incorporated in which ceramic matrix are carbon fibres or ceramic fibres or a mixture of these fibres.

The ceramic material is then a composite material. Such a composite material may be advantageous for the portions of the slide valves subjected to stretching and shear stresses. In particular, the fibres may be positioned randomly (pseudo-isotropically) or anisotropically. An anisotropic distribution of the fibres may be advantageous in particular zones, for example the end zones intended to be assembled with another material or with another part of the same material (mechanical assembly or welding, brazing) or in the case of zones subjected to a considerable stretching/shear stress. When they are present, these fibres may represent from 0.1% to 10% by weight of the composite material.

The carbon fibres may be carbon fibres with graphite planes oriented along the fibre.

The ceramic fibres may be selected from crystalline alumina fibres, mullite (3Al₂O₃, 2SiO₂) fibres, crystalline or amorphous silicon carbide fibres, zirconia fibres, silica-alumina fibres, or mixtures thereof.

Preferably, the composite ceramic material comprises a silicon carbide SiC matrix comprising fibres of the aforementioned type. Preferably, the fibres are silicon carbide fibres.

Advantageously and non-limitingly, the ceramic material may be a sintered ceramic material or a CMC material (CMC=Ceramic Matrix Composite. This may in particular facilitate the production of the portions of the slide valve subject to erosion, whether these are made from a single part or from several parts.

Advantageously and non-limitingly, the devices according to the invention, and in particular the portions subject to erosion entirely made of ceramic material, are preferably made of CMC materials (CMC=Ceramic Matrix Composite), here identified as CMC devices. In other words, the composite material here above mentioned may be a CMC.

A method of preparation of these CMC portions is preferably performed as follows:
1) Shaping a fibrous ceramic material eventually over a supporting material that could be removed without excessive effort, in order to obtain a fibrous shape that can be assimilated to the backbone of the final portion to be obtained, eventually in the presence of a first resin,
2) Coating the shape obtained at step (1) with finely divided ceramic powder and at least a second resin, eventually in the presence of finely divided carbon powder, to obtain a coated shape,
3) Eventually repeat steps (1) and (2),
4) Heating the coated shape of step (2) or (3) under vacuum and/or under inert atmosphere in order to transform the resins of step (1), (2) and eventually (3) into a carbon-rich structure, essentially deprived of other elements to obtain a carbon-rich coated shape,
5) Introducing a gas within the carbon-rich coated shape of step (4) under conditions efficient to transform the carbon-rich structure into carbide containing carbon-rich structure,
6) Eventually removing the supporting material of step (1), when present,

wherein carbon fibers are present at least at step (1), (2) and/or (3) within the fibrous ceramic material, within the finely divided ceramic powder, within the finely divided carbon powder, and/or within the first and/or second resin.

Preferably, the mixture of finely divided ceramic powder comprises ceramic fibers with lengths comprised between 100 nm to 5 mm in an amount from 0.1 to 20 Wt % relative to the total amount of finely divided ceramic powder+finely divided carbon powder when present.

Preferably, the fibrous ceramic material is made of non-woven fabric, woven fabric or knit made with at least one of thread, yarn, string, filament, cord, string, bundle, cable, eventually sewed to maintain the desired shape. The fibrous ceramic material and the resins can be present in an amount up to 50 wt % relative to the total amount of components. In these conditions, if a CMC is manufactured with 50 Wt % fibrous ceramic material and resins, and ceramic powder comprising 20 Wt % ceramic fibers is added, the overall content in free fibers, i.e. not contained in the fibrous ceramic material, before any thermal treatment, is 10 Wt %. (Wt %=weight percent).

The fibrous ceramic material is preferably made with carbon and/or silicon carbide fibers.

The first, second and further resin are independently selected among resins able to produce a carbon residue and to bind the different constituents of the ceramic material before thermal treatment. Suitable resins include preferably poly-methacrylic acid, poly methyl methacrylate, poly ethyl methacrylate, polymethacrylonitrile, polycarbonates, polyesters, polyolefins such as polyethylene and polypropylene, polyurethanes, polyamides, polyvinyl butyral, polyoxyethylene, phenolic resins, furfuryl alcohol resins, usual polymer precursors of carbon fibers such as polyacrylonitrile, rayon, petroleum pitch. The resins and their quantities are adjusted to the desired porosity that is obtained after thermal treatment of step (4) and before step (5). Preferably, the total porosity after treatment of step (4) should be comprised between 15 vol % and 25 vol %, more preferably between 20 vol % and 22 vol %. (Vol %=volume percent). Without wishing to be bound by theory, it is assumed the resins, when undergoing thermal treatment of step (4) transform into a network of cavities containing residual carbon atoms surrounded with voids. It is assumed the gas of step (5) moves preferentially within this network thus allowing improved homogeneity in the final CMC material. For example, 78 Wt % SiC powder which contains 0.2 Wt % of silicon carbide fiber is mixed with 17 Wt % phenolic resin and 5 Wt % poly methyl methacrylate and this mixture is used to impregnate and cover a silicon carbide fabric (which accounts for 20 Wt % of the overall weight) that surrounds a shaping support, then heated under inert gas atmosphere until complete carbonization of the resins to obtain a final product having from 16 vol % to 18 vol % total porosity.

The gas may be selected among SiH₄, SiCl₄, ZrCl₄, TiCl₄, BCl₃, to form corresponding carbide.

Preferred gas is SiH₄ or SiCl₄.

Preferred conditions of step (5) are standard RCVI conditions (Reactive Chemical Vapor Infiltration), more preferably using pulsed pressure.

Preferably steps (4) and (5) are each independently performed at a temperature comprised between 1100 and 1800° C. and at an absolute pressure comprised between 0.1 and 1 bar.

Preferably, the finely divided ceramic powder comprises, or eventually consists of, particles selected from silicon carbide SiC, boron carbide B₄C, silicon nitride Si₃N₄, aluminium nitride AlN, boron nitride BN, alumina Al₂O₃, or mixtures thereof.

Preferably, the finely divided carbon powder is carbon black.

A suitable but non limiting particle size range for the finely divided ceramic powder, and eventually finely divided carbon powder, is about 10 micrometers or less.

Such a method of preparation allows improved homogeneity in the CMC material in that porosity gradient and clogging at the surface of the material is considerably reduced or totally alleviated, depending on the experimental conditions (low temperatures ca. 1100-1300° C. and reduced pressure ca. 0.1-0.5 bar abs. are preferred).

In one particular embodiment, when at least said portions of the slide valve subject to erosion are made entirely of ceramic material, this ceramic material may be a sintered ceramic material.

Each portion entirely made of ceramic material of the slide valve according to the invention may especially be made from one part, without welding or assembly, for example obtained by sintering. The sintering step may be preceded by a conventional shaping step, for example by compression, extrusion or injection.

Each portion may also be formed for example by moulding or by extrusion, followed by a firing of the green portion, under conventional operating conditions suitable for the type of ceramic produced. The firing step is optionally preceded by a drying step.

Sintering is a process for manufacturing parts that consists in heating a powder without melting it. Under the effect of heat, the grains fuse together, which forms the cohesion of the part. Sintering is especially used for obtaining the densification of ceramic materials and has the following advantages:
it makes it possible to control the density of the substance; as a powder is used to start with and since this powder does not melt, it is possible to control the size of the powder grains (particle size) and the density of the material, depending on the degree of initial compacting of the powders;
it makes it possible to obtain materials having a controlled porosity, that are chemically inert (low chemical reactivity and good corrosion resistance) and thermally inert;
it makes it possible to control the dimensions of the parts produced: as there is no change of state, the variations in volume and in dimensions are not very large compared to melting (absence of shrinkage phenomenon).

In another particular embodiment, a portion of the slide valve entirely made of ceramic material may be made of several separate parts assembled together.

Advantageously and non-limitingly, the inner walls of the slide valve may be smooth, in other words they may have a low surface roughness. This makes it possible to limit the adhesion of particles to these walls and also enables the reduction of the formation of catalyst fines and therefore a reduction of the catalyst losses and a reduction of the operating costs of an FCC unit. They may also make it possible to reduce the pressure drops and may improve the flexural strength of the portions made of ceramic material.

Such a smooth wall may be obtained when the ceramic material is a sintered ceramic material.

Advantageously and non-limitingly, the portions made of ceramic material may be obtained from a relatively fine sintering powder, for example having a mean grain diameter of less than or equal to 500 nm, which may result in relatively smooth surfaces.

Alternatively or in addition, the portions made of ceramic material may be obtained by adding to the main material, for example SiC, an additive selected from boron B, silicon Si and carbon C, or mixtures thereof, for example in a proportion varying from 0.3% to 2% by weight. In the case of an SiC material obtained by powder sintering, such an addition of additive may make it possible to reduce the porosity and consequently the roughness.

Advantageously and non-limitingly, the additive may comprise a mixture of boron B, silicon Si and carbon C. It may thus form additional SiC, which blocks the pores and thus reduces the roughness.

Alternatively or in addition, a step of additional deposition of SiC by chemical vapour deposition (CVD) could for example be provided.

As already mentioned, a portion entirely made of ceramic material of the slide valve may be made of one part or of several separate parts assembled together. In particular, the portions of the slide valve subject to erosion, for example the body and said at least one gate, when they are entirely made of ceramic material, may thus result from the assembling of several separate parts made of ceramic material, each for example obtained by sintering.

The separate parts made of ceramic material of the slide valve may be assembled by welding or brazing. The assembling may for example be carried out by a diffusion welding process, for example as described in document US 2009/0239007 A1.

As a variant or in combination, the separate parts made of ceramic material of the slide valve may have ends that are shaped in order to be assembled by interlocking or screwing.

Advantageously, the ends of the parts assembled by interlocking or screwing may have a conical shape, which may make it possible to simply reduce the stresses between the parts and to improve the leaktightness between the parts.

Advantageously, each separate part may be a cone section or cylinder section, and these separate parts may be assembled by screwing or interlocking of their ends, or by welding or brazing.

Advantageously, for better leaktightness, a seal may be positioned between the separate parts assembled by interlocking or screwing. It may be, for example, a seal made of carbon or made any other suitable material, for example made of vermiculite or made of another compressible and thermally stable material. Optionally, a seal may be positioned between separate parts assembled by interlocking or screwing having a conical shape.

In one particular embodiment, when said parts subject to erosion are made entirely of ceramic material, the rest of the slide valve is made of metal, for example made of steel, preferably made of stainless steel. The metal portions of the slide valve may then be connected to the portions made of ceramic material of the slide valve by fastening means capable of absorbing a difference in expansion between the metal and the ceramic material.

For example, such fastening means may be formed by a layer of materials essentially comprising assembled ceramic fibres having a non-zero elastic modulus, this layer being positioned between a portion made of ceramic material and a metal portion and providing the cohesion of these portions. Alternatively, the geometry and the dimensions of the fastening means may be adapted in order to compensate for the difference in thermal expansion between the metal and the ceramic material.

Generally, this type of fastening means may be used for assembling metal portions of the slide valve to portions made of ceramic material of the slide valve (for example fixed portions) or else for assembling portions made of ceramic material of the slide valve (for example fixed portions) to a metal duct in which the fluid to be controlled circulates.

Such fastening means may comprise portions that interlock or screw together, preferably conical portions. For example, the portions to be assembled advantageously have a rotational symmetry, and their ends have complementary conical shapes.

As a variant, the fastening means may comprise one (or more) pressing element(s) capable of exerting an elastic force on a portion made of ceramic material to be assembled to a metal portion in order to press this portion made of ceramic material against the metal portion.

Thus, the fastening withstands the differential expansion between the material of the metal portion, for example a steel, preferably a stainless steel, and the ceramic material. Indeed, the ceramic may have a coefficient of thermal expansion that is much lower than that of the steel.

The pressing element may for example comprise a spring means, or other means. It will be possible, for example, to provide one or more fastening tabs that are firmly attached to (or form a single part with) a metal portion, for example that are welded. These tabs, on the one hand welded via one end to the metal portion, while the other end rests on a surface of a portion made of ceramic material, make it possible to exert an elastic bearing force on the portion made of ceramic material so as to keep this portion pressed against the metal portion. This other end may have a relatively flat surface in order to limit the zones of high mechanical stresses.

In particular, the fastening means may comprise at least one metal tab firmly attached to a fastening face of a metal portion and capable of elastically bearing against an edge of a portion made of ceramic material in order to keep this edge bearing against the fastening face. The fastening face and the edge may extend over the entire periphery of the ends to be assembled. They may be flanges.

According to one preferred embodiment, all of the constituent elements of the slide valve are made of ceramic material, with the exception of the valve actuating devices, which are customarily hydraulic control devices. In this case, the parts subjected to shear stresses are manufactured from ceramic material, preferably reinforced by ceramic fibres.

The invention also relates to a catalytic cracking unit comprising at least one slide valve according to the invention, in particular for controlling the circulation of the catalyst flow inside said unit.

The invention is now described with reference to the appended, non-limiting drawings, in which:

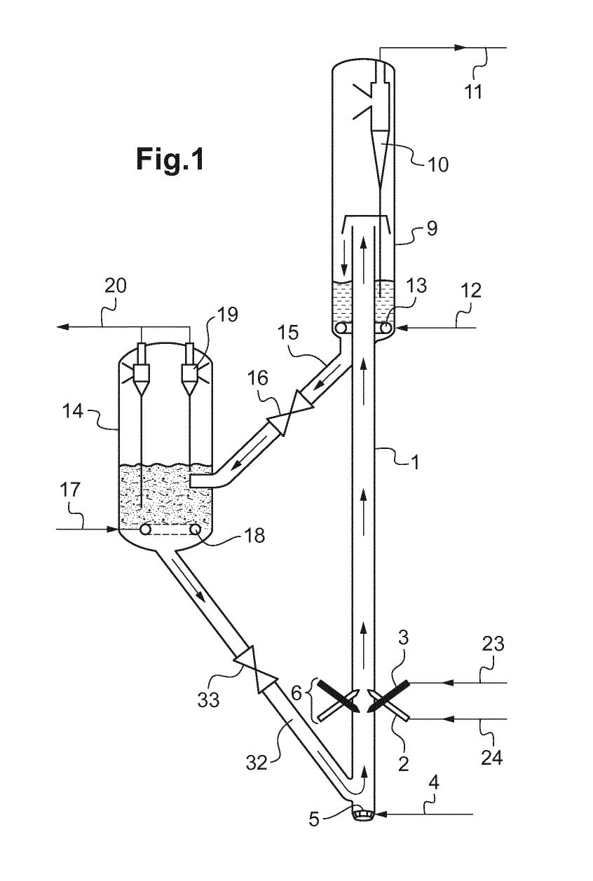

FIG. 1 is a schematic representation of an FCC unit;

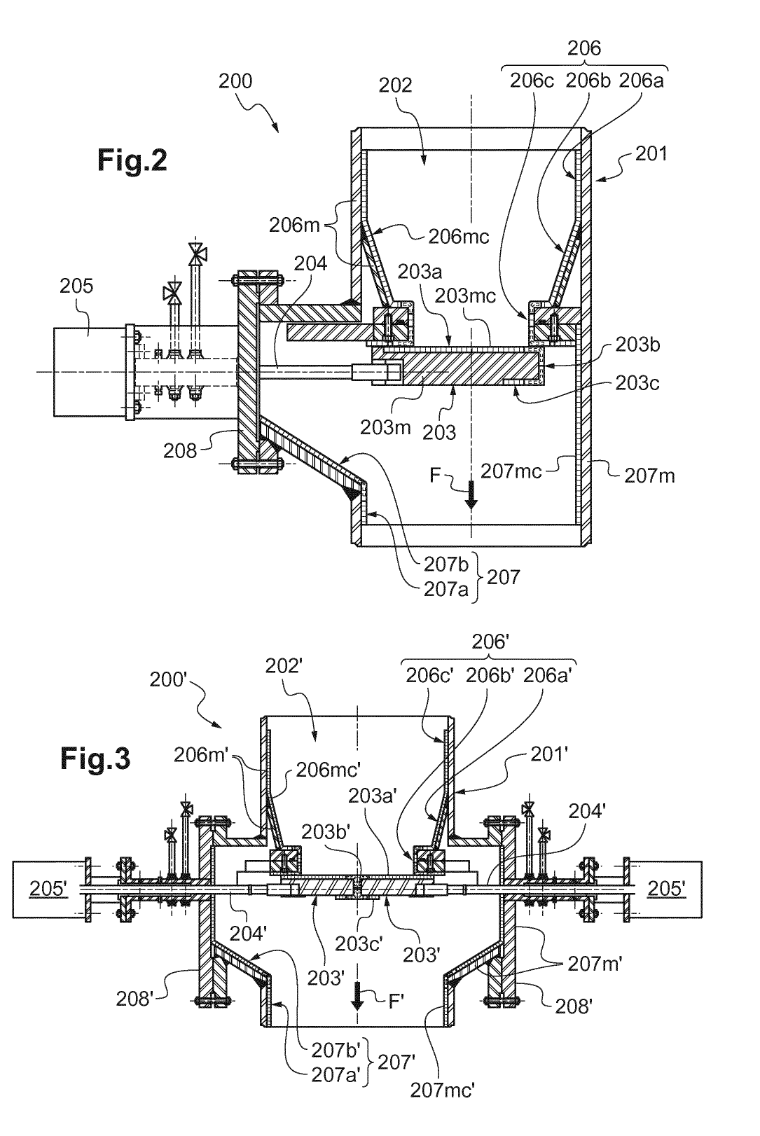

FIG. 2 is a schematic representation, in longitudinal cross section, of a slide valve according to one embodiment of the invention;

FIG. 3 is a schematic representation of a slide valve according to another embodiment of the invention;

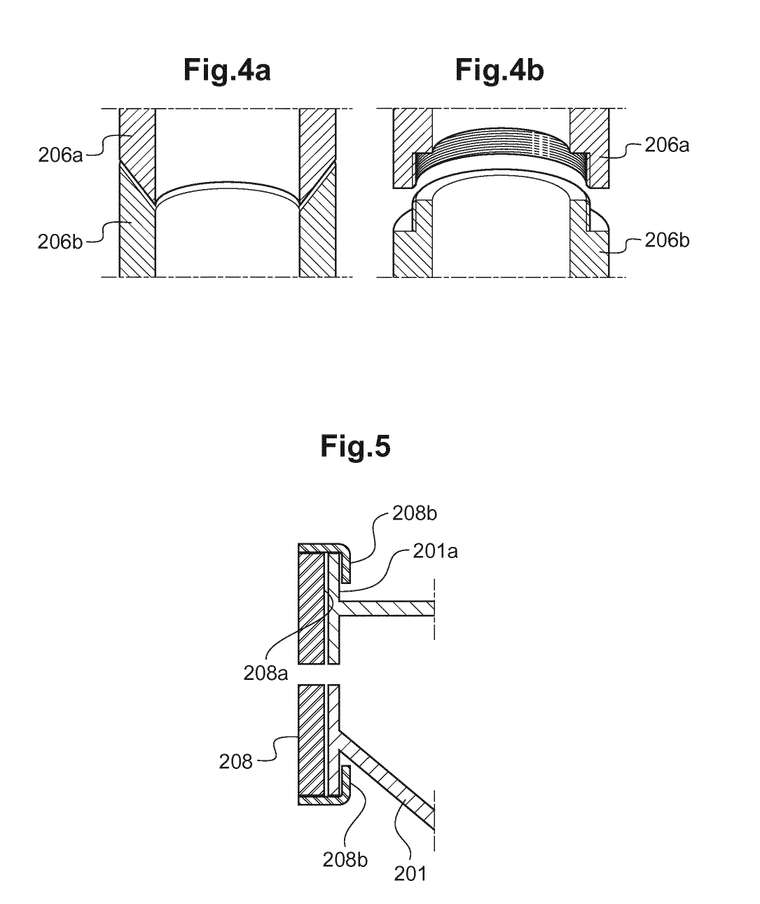

FIGS. 4a and 4b are axial cross-sectional views of the ends of two assembled parts. The assembled parts are separated in FIG. 4b for greater clarity;

FIG. 5 shows an example of assembling a metal plate to a valve body made of ceramic material.

FIG. 1 represents a fluid catalytic cracking unit equipped with a reactor having an essentially ascending flow. This unit is of a type known per se. It comprises in particular a column-shaped reactor 1, referred to as a feedstock riser or riser, supplied at its base via a duct 32 with regenerated catalyst grains in a predetermined amount. A riser gas, for example steam, is introduced into the column 1 through the line 4, by means of a diffuser 5.

The feedstock to be cracked is introduced at the injection zone 6, which comprises injectors 2 and 3. The column 1 opens, at its top, into a chamber 9, referred to as a disengager, in which the separation of the cracking products and the stripping of the deactivated catalyst particles are carried out. The cracking products are separated from the spent catalyst particles in a cyclone 10, which is housed in the chamber 9, at the top of which a line 11 is provided for discharging the cracking products, whilst the deactivated catalyst particles move by gravity to the base of the chamber 9. A line 12 supplies fluidizing gas injectors or diffusers 13, uniformly arranged at the base of the chamber 9, with stripping fluid, generally steam. One or more other cyclones may be provided inside the chamber 9.

The deactivated catalyst particles thus stripped are discharged at the base of the chamber 9 to a regenerator 14, through a duct 15, along which a control valve 16 is provided. In the regenerator 14, the coke deposited on the catalyst particles is burnt using air, injected at the base of the regenerator via a line 17, which supplies uniformly spaced injectors or diffusers 18. The treated catalyst particles, entrained by the flue gas, are separated by cyclones 19, from which the flue gas is discharged through a line 20, whilst the catalyst particles are discharged to the base of the regenerator 14, from where they are recycled to the feed of the riser 1 via the duct 32, equipped with a control valve 33.

The control valves 16 and 33 are generally slide valves.

A slide valve according to the invention may be arranged in accordance with any one of the slide valves known in the prior art.

Some of these slide valves are described with reference to FIGS. 2 and 3. The invention is not however limited to these embodiments.

FIG. 2 represents a slide valve 200 comprising a body 201 having a through-duct 202 for the passage of a fluid, the flow rate of which is to be controlled. The slide valve also comprises a gate 203 slidably mounted inside the body 201, crosswise to the direction F of the flow. This gate 203 is conventionally in the form of a plate connected to a rod 204 itself connected to an actuating device 205 which controls the movement of the rod 204 and of the adjoining gate 203. This actuating device 205 is for example a hydraulic actuating device, such as a piston.

This actuating device 205 may thus move the gate 203 between a position in which the duct 202 is closed off (as represented in FIG. 2) and a position in which the duct 202 is open (not represented).

Certain portions of the slide valve 200 are subject to erosion. These are the portions of the body delimiting the duct, namely the sidewalls 206 of the duct located upstream of the gate 203 with respect to the direction of circulation F of the fluid through the slide valve 200 and also at least one portion of the sidewalls 207 of the duct located downstream of the gate 203. In the example represented, the sidewalls 206 upstream comprise a cylindrical portion 206a, followed by a conical portion 206b then again by a cylindrical portion 206c, from upstream to downstream in the direction of the gate 203. The sidewalls 207, downstream, are essentially cylindrical 207a and partially conical 207b in the vicinity of the rod 204 of the gate 203.

Of course, the invention is not limited to the shape of the duct 202 represented.

Certain portions of the gate 203 are also subject to erosion. These are at least the portion of the gate 203 located across the duct 202 when the gate partially or completely closes off the duct 202. Thus, in the example, these are the upstream surface 203a (facing upstream) of the gate, its end 203b (parallel to the flow of the stream F) and a portion of the downstream surface 203c (pointing downstream).

In the example represented, these various portions 203, 206, 207 subject to erosion are formed of a metal wall 203m, 206m, 207m respectively, covered with a layer of ceramic material 203mc, 206mc, 207mc. As a variant, these metal walls could be entirely made of ceramic material, preferably made of silicon carbide SiC. They are for example formed by injection moulding or extrusion. Injection moulding or extrusion are conventionally carried out using ceramic powders or precursors of ceramics with a binder. According to another manufacturing method, the ceramic walls are formed by compression and heating of a ceramic powder, it being possible for the compression to be maintained during the heating step, the heating step being a step of sintering the ceramic powder. This technique is particularly well suited to the manufacture of solid elements made of silicon carbide according to the invention. The ceramic powder used optionally comprises ceramic fibres in order to increase the mechanical strength of the parts produced. The ceramic fibres, when they are present, generally represent from 0.1% to 10% by weight of the part produced.

FIG. 3 represents another embodiment of a slide valve 200′, which differs from the preceding embodiment by:
the presence of two gates 203′ each connected to a rod 204′ itself connected to an actuating device 205′
the shape of the duct 202′ downstream of the gates 203′, which has a conical shape 207b′ followed by a cylindrical shape 207a′ from upstream to downstream starting from the gates 203′.

In FIG. 3, the elements identical to the elements from FIG. 2 bear the same reference followed by a prime “'”. The gates 203′ are not described in detail but are similar to the gate 203 described with reference to FIG. 2. A fluid may thus circulate through the slide valve 200′ following the moving of the two gates 203′ apart from one another, their coming together making it possible, on the contrary, to reduce the flow rate until all circulation of fluid is prevented in the position represented in FIG. 3.

Furthermore, the portions subject to erosion are the same as those from FIG. 2. In FIG. 3, only the portions of one of the gates 203′ subject to erosion have been represented for the greater clarity. In the same way as for FIG. 2, the portions in question may be entirely made of ceramic material.

In one variant of the two embodiments described with reference to FIGS. 2 and 3, all of the body 201, 201′ may be made of ceramic material, or at the very least the portions of the body forming the walls of the duct 202, 202′. The body 201, 201′ may be entirely made of ceramic material, produced from one part (without welding or assembling), for example by sintering. Or at least the portions of the body forming the walls of the duct 202, 202′ may be entirely made of ceramic material, produced from one part, for example by sintering. In this case, the portions from FIGS. 2, 3 comprising a metal wall covered with a layer of ceramic material are replaced by walls entirely made of ceramic material.

These portions entirely made of ceramic material may also be produced from several separate parts assembled together. For example, the cylindrical portion 206a (or 206′a) of the duct 202 (or 202′) may be a separate part and may be assembled to the conical portion 206b (or 206′b) of the duct 202 (or 202′). The parts 206a and 206b may then be interlocked, as represented schematically in FIG. 4a by interlocking of conical end portions of complementary shape, or by screwing of their ends (FIG. 4b), or else welded or brazed (not represented). The other portions of the duct (206c, 207a, 207b) or (206′c, 207′a, 207′b) may also be separate parts that are assembled as described above. Similarly, the body (201 or 201′) may be made of several separate parts that are assembled as described above.

In FIGS. 2 and 3, the body 201, 201′ comprises one or two support plates 208, 208′ supporting the rod 204, respectively the rods 204′. If the body is made of ceramic material, this support plate (208 or 208′) may be made of metal. The connection between the plate 208, 208′ and the body 201, 201′ is then different from the screw connection represented in FIGS. 2 and 3, this connection being obtained by fastening means capable of absorbing a difference in expansion between the metal and the ceramic material.

By way of example, as represented schematically in FIG. 5, the plate 208 has a fastening face 208a, attached to which are at least two metal tabs 208b that are shaped to bear against an edge 201a of the body 201 in order to keep this edge 201a bearing against the fastening face 208a of the plate. This edge 201a may form a flange. A similar fastening may be made between metal plates 208′ and a body 201′ made of ceramic material.

Fastening means capable of absorbing a difference in expansion between the metal and the ceramic material, for example of the type described above, could also be used to fasten a slide valve, the body of which is made of ceramic material, to a metal duct in which the fluid, the flow rate of which must be controlled, circulates.

The invention has been described with reference to an FCC unit operating with a reactor having an ascending flow (“riser”), the valves according to the invention may however also be used in FCC units operating with a reactor having an descending flow (“downer”).

1.-10. (canceled)

11. A slide valve comprising:
a body having a through-duct for the passage of a fluid, the flow rate of which is to be controlled,
at least one gate slidably mounted inside the body, crosswise to the duct, and partially or completely closing off the duct, the gate being movable between a position in which the duct is partially or completely closed off and a position in which the duct is open,
in which the following are defined as portions subject to erosion:
portions of the body that delimit the duct, at least one portion of the at least one gate located across the duct when
the at least one gate partially or completely closes off the duct, characterized in that at least the portions subject to erosion are made of metal covered with a layer of ceramic material or are entirely made of ceramic material and the ceramic material comprises a ceramic matrix selected from the group consisting of silicon carbide SiC, boron carbide B₄C, silicon nitride Si₃N₄, aluminium nitride AlN, boron nitride BN, alumina Al₂O₃, and mixtures thereof, wherein carbon fibres or ceramic fibres are incorporated in the ceramic matrix.

12. The slide valve according to claim 11, characterized in that the ceramic fibres comprise crystalline alumina fibres, mullite fibres, crystalline or amorphous silicon carbide fibres, zirconia fibres, silica-alumina fibres, or mixtures thereof.

13. The slide valve according to claim 11, characterized in that, when the portions of the slide valve subject to erosion are made entirely of ceramic material, the ceramic material is a sintered ceramic material.

14. The slide valve according to claim 11, characterized in that, when the portions of the slide valve subject to erosion are made entirely of ceramic material, the ceramic material is a Ceramic Matrix Composite (CMC).

15. The slide valve according to claim 11, characterized in that the body, or at least the portions of the body delimiting the duct, and the at least one gate are entirely made of ceramic material.

16. The slide valve according to claim 11, characterized in that a portion entirely made of ceramic material is made of several separate parts assembled together by welding or brazing.

17. The slide valve according to claim 11, characterized in that a portion entirely made of ceramic material is made of several separate parts assembled together and in that the separate parts have ends that are shaped in order to be assembled by interlocking or screwing.

18. The slide valve according to claim 11, characterized in that the portions subject to erosion are made entirely of ceramic material, the rest of the slide valve being made of a material other than ceramic, the portions of the slide valve made of material other than ceramic being connected to the portions made of ceramic material of the slide valve by fastening means capable of absorbing a difference in expansion between the non-ceramic material and the ceramic material.

19. Catalytic cracking unit comprising at least one slide valve according to claim 11.

20. A method of preparation of a slide valve, comprising a preparation step for portions of the slide valve subject to erosion made entirely of ceramic material which is Ceramic Matrix Composite (CMC), the step comprising:
1) shaping a fibrous ceramic material over a supporting material that could be removed without excessive effort, in order to obtain a fibrous shape that can be assimilated to the backbone of the portion to be obtained, in the presence of a first resin,
2) coating the shape obtained at step (1) with finely divided ceramic powder and at least a second resin, in the presence of finely divided carbon powder, to obtain a coated shape,
3) repeat steps (1) and (2),
4) heating the coated shape of step (2) or (3) under vacuum and/or under inert atmosphere in order to transform the resins of step (1), (2) and (3) into a carbon-rich structure, essentially deprived of other elements to obtain a carbon-rich coated shape,
5) introducing a gas within the carbon-rich coated shape of step (4) under conditions efficient to transform the carbon-rich structure into carbide containing carbon-rich structure,
6) removing the supporting material of step (1), when present,
wherein carbon fibers are present at least at step (1), (2) and/or (3) within the fibrous ceramic material, within the finely divided ceramic powder, within the finely divided carbon powder, and/or within the first and/or second resin.
